(19) United States
(12) Patent Application Publication
(10) Pub. No.: US 2006/0187633 A1
(43) Pub. Date: Aug. 24, 2006

(54) Computer having drawer

(76) Inventors: Jen-Yuan Huang, Taipei (TW); Jui-Hua Lin, Taipei (TW)

Correspondence Address: RABIN & Berdo, PC, 1101 14TH STREET, NW, SUITE 500, WASHINGTON, DC, 20005, US

(21) Appl. No.: 11/359,615

(22) Filed: Feb. 23, 2006

(30) Foreign Application Priority Data
Feb. 23, 2005 (TW) 94105496

(51) Int. Cl. G06F 1/16

(52) U.S. Cl. 361/685

(57) ABSTRACT

A computer is provided. The computer includes a computer housing and a drawer. The computer housing has an accommodation space and an opening. The drawer is disposed in the accommodation space for sliding into or out of the opening.

This application claims the benefit of Taiwan application Serial No. 94105496, filed Feb. 23, 2005, the subject matter of which is incorporated herein by reference.

### BACKGROUND OF THE INVENTION

1. Field of the Invention

The invention relates in general to a computer, and more particularly to a computer having a drawer.

2. Description of the Related Art

With the rapid advance in science and technology, computer has become an indispensable part to modern people in their everyday life. Computer at least includes a computer housing, a motherboard, a CPU, a memory, a display card and a hard disc. The motherboard, the CPU, the memory, the display card and the hard disc are all disposed inside the computer housing. The CPU, the memory, the display card and the hard disc are coupled to the motherboard through cable or the electrical slot of the motherboard.

By hollowing a lateral plate of the computer housing, the optical disc drive or the hard disc may enter or leave the computer housing through an opening disposed on a lateral surface of the computer housing. When the optical disc drive or the hard disc is separated with the computer housing, a shield is used to cover up the opening disposed on the lateral surface of the computer housing to prevent the dusts or objects from entering into the computer housing. Besides, the shield is an ornament decorating the appearance of the housing. However, there will be more idled space inside the computer housing when computer housing may allow more than two removable electronic components to be disposed inside the computer housing, wasting the space inside computer housing a lot.

As there are more and more small-sized electronic components or recording media, such as disc, handy disc, wireless mouse and receiver, the user has to think about how to store up the abovementioned small-sized electronic components or recording media and at the same time these components or recording media must be easy to locate when needed.

### SUMMARY OF THE INVENTION

It is therefore the object of the embodiment to provide a computer having a drawer. The design of drawer enables the user to store up a small-sized electronic component or recording media inside the computer, which is indeed very convenient. Therefore, the internal space of the computer is better utilized, largely enhancing the practicality of computer.

According to an object of the embodiment, a computer is provided. The computer includes a computer housing and a drawer. The computer housing has an accommodation space and an opening. The drawer is disposed in the accommodation space for sliding into or out of the opening.

According to another object of the embodiment, a computer is provided. The computer includes a computer housing, a drawer, two guide plates, two slide tracks and two slide slots. The computer housing has at least one accommodation space, a first opening and a second opening. The two guide plates are disposed in the accommodation space. The two slide slots are correspondingly disposed on two adjacent inner surfaces of the two guide plates. The drawer is disposed in the accommodation space for sliding into or out of the first opening. The two slide tracks are correspondingly projected from two opposite outer surfaces of the drawer to be inserted into and slidden with respect to the two slide slots, so that the drawer may slide into or out of the accommodation space through the first opening. Besides, the optical disc drive is disposed in the accommodation space for sliding into or out of the second opening.

According to yet another object of the embodiment, a computer is provided. The computer includes a computer housing, a drawer, two guide plates, two slide tracks, two slide slots and an optical disc drive. The computer housing has at least one accommodation space, a first opening and a second opening. The two guide plates are disposed in the accommodation space. The two slide tracks are correspondingly projected from two adjacent inner surfaces of the two guide plates. The drawer is disposed in the accommodation space for sliding into or out of the first opening. The two slide slots are correspondingly disposed on two opposite outer surfaces of the drawer to be inserted into and slidden with respect to the two slide tracks, so that the drawer may slide into or out of the accommodation space through the first opening. Besides, the optical disc drive is disposed in the accommodation space for sliding into or out of the second opening.

The abovementioned computer may further include a hard disc, the computer housing further has a third opening. The hard disc is slidden into or out of the third opening and is disposed in the accommodation space.

Other objects, features, and advantages of the embodiment will become apparent from the following detailed description of the preferred but non-limiting embodiments. The following description is made with reference to the accompanying drawings.

### BRIEF DESCRIPTION OF THE DRAWINGS

FIGS. 1A-1B are two exploded diagrams of a computer having a drawer according to a first embodiment of the invention; and

FIGS. 2A-2B are two exploded diagrams of a computer having a drawer according to a second embodiment of the invention.

### DETAILED DESCRIPTION OF THE INVENTION

The invention provides a computer having a drawer. The computer of the invention includes a computer housing, a drawer and an optical disc drive. The computer housing has at least an accommodation space, a first opening and a second opening. The drawer is disposed in the accommodation space for sliding into or out of the first opening. The optical disc drive (ODD) is disposed in the accommodation space for sliding into or out of the second opening. The computer of the invention may further include a hard disc (HD). The computer housing further has a third opening. The hard disc is disposed in the accommodation space for sliding into or out of the third opening.

For the drawer to slide to be disposed in the accommodation space, the invention provides a computer including a slide guiding mechanism. The slide guiding mechanism is disposed between the computer housing and the drawer for guiding the drawer to slide into or out of the accommodation space through the first opening, so that the drawer can be disposed in the accommodation space. The abovementioned drawer may accommodate a small-sized electronic component or recording media, such as disc, handy disc, wireless mouse receiver and so forth.

When the drawer is separated from the computer housing, the optical disc drive or the hard disc may slide into or out of the accommodation space through the first opening, the second opening or the third opening to be disposed in the accommodation space. Moreover, the optical disc drive or the hard disc may utilize the abovementioned slide guiding mechanism through the first opening, the second opening or the third opening to slide into or out of the accommodation space to be disposed in the accommodation space. Apart from that, several drawers disposed outside the computer housing are stacked together orderly without occupying too much space. As for the design of the computer having a drawer and the slide guiding mechanism is exemplified by a first embodiment and a second embodiment elaborated below.

### FIRST EMBODIMENT

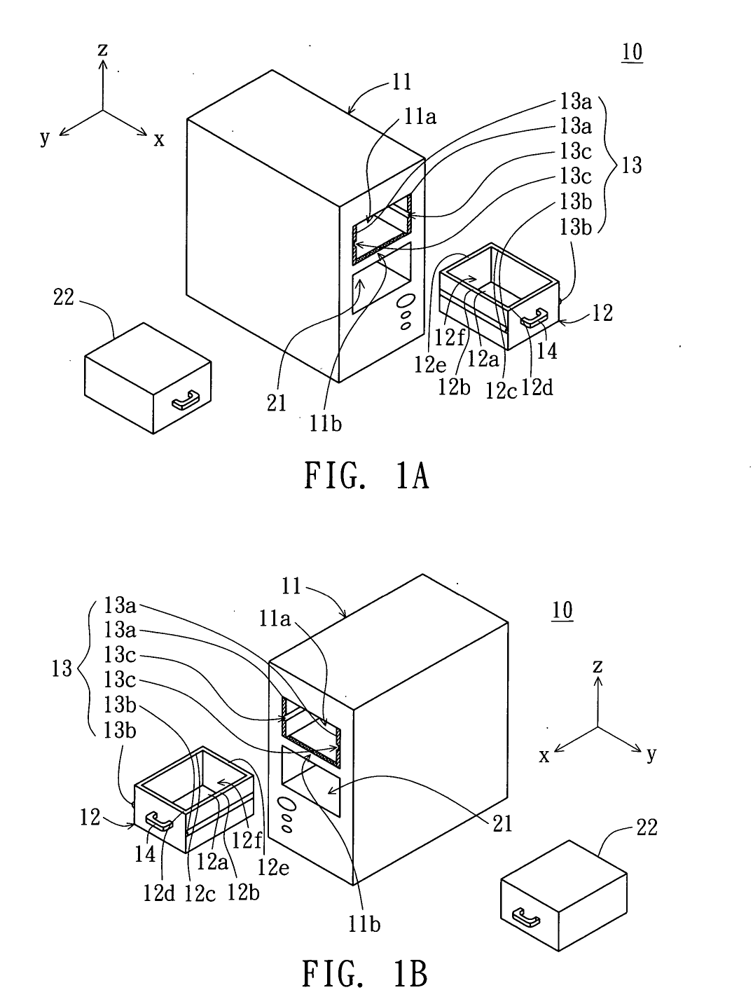

Referring to both FIGS. 1A˜1B, two exploded diagrams of a computer having a drawer according to a first embodiment of the invention are shown. In FIGS. 1A˜1B, the computer 10 at least includes a computer housing 11 and a drawer 12. The computer housing 11 has at least one accommodation space 11a and at least an opening 11b. The drawer 12 is disposed in the accommodation space 11a for sliding into or out of the opening 11b. The computer 10 further has includes-an optical disc drive 22. The computer housing 11 further has an opening 21. The optical disc drive 22 is disposed in the accommodation space 11a for sliding into or out of the opening 21.

According to the present embodiment, the computer 10 further includes a slide guiding mechanism 13. The slide guiding mechanism 13 is disposed between the computer housing 11 and the drawer 12 for guiding the drawer 12 to slide into or out of the accommodation space 11a through the opening 11a and along the ±x direction, so that the drawer 12 is disposed in the accommodation space 11a.

The slide guiding mechanism 13 includes two guide plates 13a, two slide tracks 13b and two slide slots 13c. The two guide plates 13a are disposed in the accommodation space and may be buckled with, coupled to, locked with or screwed into the inner wall of the computer housing 11. The two slide slots 13c are correspondingly disposed on two-adjacent inner surfaces of the two guide plates 13a. The two slide tracks 13b are correspondingly projected from two opposite outer surfaces of the drawer 12 to be inserted into and slidden with respect to the two slide slots 13c, so that the drawer 12 may slide into or out of the accommodation space 11a through the opening 11b.

Besides, the drawer 12 includes a bottom plate 12a, a first lateral plate 12b, a second lateral plate 12c, a third lateral plate 12d and a fourth lateral plate 12e. The first lateral plate 12b, the second lateral plate 12c, the third lateral plate 12d and the fourth lateral plate 12e are all disposed on the bottom plate 12a. The first lateral plate 12b and the third lateral plate 12d respectively correspond to the second lateral plate 12b and the fourth lateral plate 12e. The first lateral plate 12b and the second lateral plate 12c connect the third lateral plate 12d and the fourth lateral plate 12e, so that the first lateral plate 12b, the second lateral plate 12c, the third lateral plate 12d, the fourth lateral plate 12e and the bottom plate 12a become a storage recess 12f. The abovementioned two slide tracks 13b are correspondingly projected from the outer surface of the first lateral plate 12b and that of the second lateral plate 12c. Apart from that, the drawer 12 further includes a handle 14, which is disposed on the outer surface of the third lateral plate 12d for enabling a user to apply a force to slide the drawer 12 into or out of the accommodation space 11a. When the user would like to place the drawer 12 of FIGS. 1A˜1B in the accommodation space 11a, firstly, the user must turn the outer surface of the fourth lateral plate 12e to face the opening 10b, and align the two slide tracks 13b with the two slide slots 13c. Next, when the two slide tracks 13b are inserted into the two slide slots 13c, the user may move the drawer 12 along the −x direction, so that the drawer 12 slides towards the accommodation space from the opening 10b.

The slide guiding mechanism 13 not only enables the drawer 12 to slide into or out of the accommodation space 11a, but also enables the drawer 12 to be stably positioned in the accommodation space 11a.

### SECOND EMBODIMENT

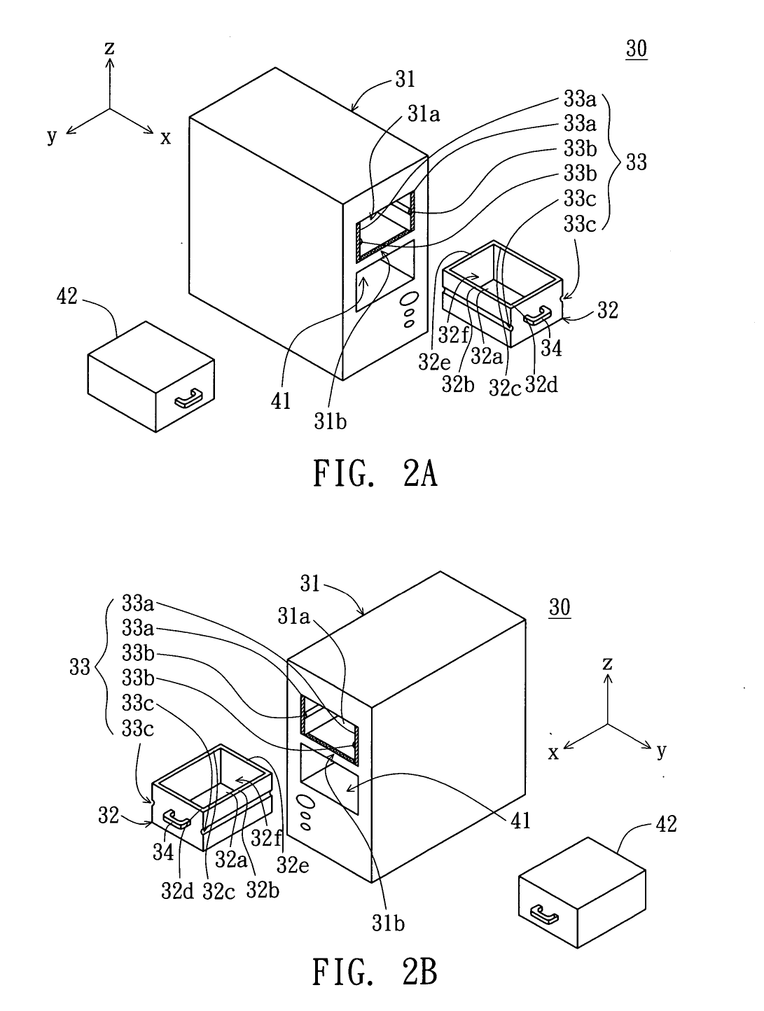

Referring to both FIGS. 2A˜2B, two assembly 3-D diagrams of the computer having a drawer according to the first embodiment of the invention are shown. In FIGS. 2A˜2B, the computer 30 at least includes a computer housing 31 and a drawer 32. The computer housing 31 has at least one accommodation space 31a and an opening 31b. The drawer 32 is disposed in the accommodation space 31a for sliding into or out of the opening 31b. The computer 30 further includes an optical disc drive 42. The computer housing 31 further has an opening 41. The optical disc drive 42 is disposed in the accommodation space 31a for sliding into or out of the opening 41.

In the present embodiment, the computer 30 further includes a slide guiding mechanism 33, which is disposed between the computer housing 31 and the drawer 32 for the guiding the drawer 32 to slide into or out of the accommodation space 31a through the opening 31a along the ±x direction, so that the drawer 32 is disposed in the accommodation space 31a.

The slide guiding mechanism 33 includes two guide plates 33a, two slide tracks 33b and two slide slots 33c. The two guide plates 33a are disposed in the accommodation space and may be buckled with, coupled to, locked with or screwed into the inner wall of the computer housing 31. The two slide tracks 33b are correspondingly projected from two adjacent inner surfaces of the two guide plates 33a. The two slide slots 33c are correspondingly disposed on two opposite outer surfaces of the drawer 32 to be inserted into and slidden with respect to the two slide tracks 33b, so that the drawer 32 may slide into or out of the accommodation space 31a through the opening 31b. Besides, the drawer 32 includes a bottom plate 32a, a first lateral plate 32b, a second lateral plate 32c, a third lateral plate 32d and a fourth lateral plate 32e. The first lateral plate 32b, the second lateral plate 32c, the third lateral plate 32d and the fourth lateral plate 32e are all disposed on the bottom plate 32a. The first lateral plate 32b and the third lateral plate 32d respectively correspond to the second lateral plate 32b and the fourth lateral plate 32e. The first lateral plate 32b and the second lateral plate 32c connect the third lateral plate 32d and the fourth lateral plate 32e, so that the first lateral plate 32b, the second lateral plate 32c, the third lateral plate 32d, the fourth lateral plate 32e and the bottom plate 32a form a storage recess 32f. The abovementioned two slide slots 33c are correspondingly disposed on the outer surface of the first lateral plate 32b and that of the second lateral plate 32c. Apart from that, the drawer 32 further includes a handle 34, which is disposed on the outer surface of the third lateral plate 32d for enabling a user to apply a force to slide the drawer 32 into or out of the accommodation space 31a.

When the user would like to place the drawer 32 of FIGS. 2A˜2B in the accommodation space 31a, firstly, the user must turn the outer surface of the fourth lateral plate 32e to face the opening 30b, and align the two slide tracks 33b with the two slide slots 33c. Next, when the two slide tracks 33b are inserted into the two slide slots 33c, the user may move the drawer 32 along the −x direction, so that the drawer 32 slides towards the accommodation space from the opening 30b. Then, after the user moves the drawer 32 for a distance and stops, the drawer 32 can be positioned in the accommodation space 31a. Meanwhile, the outer surface of the third lateral plate 32d is exposed outside the opening 30, and the handle 34 is exposed outside computer housing 31.

The slide guiding mechanism 33 not only enables the drawer 32 to slide into or out of the accommodation space 31a, but also enables the drawer 32 to be stably positioned in the accommodation space 31a.

Anyone who is skilled in the technology of the present embodiment will understand that the technology of the present embodiment is not limited thereto. For example, the bottom plate, the first lateral plate, the second lateral plate, the third lateral plate, the fourth lateral plate and the handle are formed into a one-piece molding structure. Besides, the user may accommodate small-sized electronic components or recording media, such as disc, handy disc, wireless mouse receiver and so forth in the storage recess of the drawer, and slide the drawer into the accommodation space, facilitating the computer to store up small-sized electronic components or recording media, largely enhancing the practicality of the computer. Apart from that, when the drawer and the computer housing are separated, the optical disc drive or the hard disc may slide into or out of the accommodation space through the opening to be disposed in the accommodation space. Moreover, the optical disc drive or the hard disc uses the abovementioned slide guiding mechanism to slide into or out of the accommodation space through the opening to be disposed in the accommodation space.

Apart from that, several drawers may be stacked together orderly without occupying too much space. For example, by the corresponding protruded-indented structural design between the top surface of the first lateral plate, the second lateral plate, the third lateral plate and the fourth lateral plate and the bottom of the bottom portion, the recess/protrusion on the bottom portion of the drawer at the upper layer matches with the protrusion/recess on the drawer at the lower layer, so that the drawers are stably stacked together.

When computer has several openings, an opening is for a drawer to slide into or out of the accommodation space, another opening is for an optical disc drive to slide into or out of the accommodation space, the other opening is for a hard disc to slide into or out of the accommodation space, so that the drawer, the optical disc drive and the hard disc may be disposed in the computer. When the drawer is separated from the computer housing, the optical disc drive or the hard disc may slide into or out of the accommodation space through the opening through which the drawer slides into or out of the accommodation space, providing the user with more choices.

The computer having a drawer disclosed in above embodiments of the invention is designed to have a drawer, enabling the user to store up small-sized electronic components or recording media inside the computer, providing a great convenience to the user. Therefore, the internal space of the computer is better utilized, largely enhancing the practicality of computer.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A computer, comprising:
a computer housing having an accommodation space and an opening; and
a drawer disposed in the accommodation space for sliding into or out of the opening.

2. The computer according to claim 1, further comprising:
a slide guiding mechanism disposed between the computer housing and the drawer for guiding the drawer to slide into or out of the accommodation space through the opening for the drawer to be disposed in the accommodation space.

3. The computer according to claim 2, wherein the slide guiding mechanism comprises:
two guide plates disposed in the accommodation space;
two slide slots correspondingly disposed on two adjacent inner surfaces of the two guide plates; and
two slide tracks correspondingly projected from two opposite outer surfaces of the drawer to be correspondingly inserted into and slidden with respect to the two slide slots.

4. The computer according to claim 3, wherein the drawer comprises:
a bottom plate; and
a first lateral plate, a second lateral plate, a third lateral plate and a fourth lateral plate, which are all disposed on the bottom plate, wherein the first lateral plate and the third lateral plate respectively correspond to the second lateral plate and the fourth lateral plate with the first lateral plate and the second lateral plate connecting the third lateral plate and the fourth lateral plate, so that the first lateral plate, the second lateral plate, the third lateral plate, the fourth lateral plate and the bottom plate form a storage recess;
wherein the two slide tracks are correspondingly projected from the outer surfaces of the first lateral plate and the second lateral plate;
wherein the outer surface of the third lateral plate is exposed outside the first opening when the drawer is positioned in the accommodation space.

5. The computer according to claim 1, wherein the drawer is a one-piece molding structure.

6. The computer according to claim 2, wherein the slide guiding mechanism comprises:
two guide plates disposed in the accommodation space;
two slide tracks correspondingly projected from the two adjacent inner surfaces of the two guide plates; and
two slide slots correspondingly disposed on the two opposite outer surfaces of the drawer to be inserted into and slidden with respect to the two slide tracks.

7. The computer according to claim 6, wherein the drawer comprises:
a bottom plate; and
a first lateral plate, a second lateral plate, a third lateral plate and a fourth lateral plate, which are all disposed on the bottom plate, wherein the first lateral plate and the third lateral plate respectively correspond to the second lateral plate and the fourth lateral plate with the first lateral plate and the second lateral plate connecting the third lateral plate and the fourth lateral plate, so that the first lateral plate, the second lateral plate, the third lateral plate, the fourth lateral plate and the bottom plate form a storage recess;
wherein the two slide slots are correspondingly disposed on the outer surfaces of the first lateral plate and the second lateral plate;
wherein the outer surface of the third lateral plate is exposed outside the first opening when the drawer is positioned in the accommodation space.

8. A computer, comprising:
a computer housing having at least one accommodation space, a first opening and a second opening;
two guide plates disposed in the accommodation space;
two slide slots correspondingly disposed on the two adjacent inner surfaces of the two guide plates;
a drawer disposed in the accommodation space for sliding into or out of the first opening;
two slide tracks correspondingly projected from the two opposite outer surfaces of the drawer to be inserted into and slidden with respect to the two slide slots, so that the drawer may slide into or out of the accommodation space through the first opening; and
an optical disc drive disposed in the accommodation space for sliding into or out of the second opening.

9. The computer according to claim 8, wherein the drawer comprises:
a bottom plate; and
a first lateral plate, a second lateral plate, a third lateral plate and a fourth lateral plate, which are all disposed on the bottom plate, wherein the first lateral plate and the third lateral plate respectively correspond to the second lateral plate and the fourth lateral plate with the first lateral plate and the second lateral plate connecting the third lateral plate and the fourth lateral plate, so that the first lateral plate, the second lateral plate, the third lateral plate, the fourth lateral plate and the bottom plate form a storage recess;
wherein the two slide tracks are correspondingly projected from the outer surfaces of the first lateral plate and the second lateral plate;
wherein the outer surface of the third lateral plate is exposed outside the first opening when the drawer is positioned in the accommodation space.

10. The computer according to claim 9, wherein the drawer is a one-piece molding structure.

11. A computer, comprising:
a computer housing having at least one accommodation space, a first opening and a second opening;
two guide plates disposed in the accommodation space;
two slide tracks correspondingly projected from the two adjacent inner surfaces of the two guide plates;
a drawer disposed in the accommodation space for silding into or out of the first opening;
two slide slots correspondingly disposed on the two opposite outer surfaces of the drawer to be inserted into and slidden with respect to the two slide tracks, so that the drawer may slide into or out of the accommodation space through the first opening; and
an optical disc drive disposed in the accommodation space for sliding into or out of the second opening.

12. The computer according to claim 11, wherein the drawer comprises:
a bottom plate; and
a first lateral plate, a second lateral plate, a third lateral plate and a fourth lateral plate, which are all disposed on the bottom plate, wherein the first lateral plate and the third lateral plate respectively correspond to the second lateral plate and the fourth lateral plate with the first lateral plate and the second lateral plate connecting the third lateral plate and the fourth lateral plate, so that the first lateral plate, the second lateral plate, the third lateral plate, the fourth lateral plate and the bottom plate form a storage recess;
wherein the two slide slots are correspondingly disposed on the outer surfaces of the first lateral plate and the second lateral plate;
wherein the outer surface of the third lateral plate is exposed outside the first opening when the drawer is positioned in the accommodation space.

13. The computer according to claim 12, wherein the drawer is a one-piece molding structure.
